(19) United States
(12) Patent Application Publication
(10) Pub. No.: US 2025/0071475 A1
(43) Pub. Date: Feb. 27, 2025

(54) VIBRATION ABSORPTION APPARATUS AND ELECTRONIC DEVICE

(71) Applicant: VIVO MOBILE COMMUNICATION CO., LTD., Guangdong (CN)

(72) Inventors: Xinkun CHENG, Guangdong (CN); Zhiyuan WANG, Guangdong (CN)

(73) Assignee: VIVO MOBILE COMMUNICATION CO., LTD., Guangdong (CN)

(21) Appl. No.: 18/947,078

(22) Filed: Nov. 14, 2024

Related U.S. Application Data
(63) Continuation of application No. PCT/CN2023/094716, filed on May 17, 2023.

(30) Foreign Application Priority Data
May 24, 2022 (CN) 202210573829.5

(51) Int. Cl. H04R 1/28; H04R 1/02

(52) U.S. Cl. CPC H04R 1/2888; H04R 1/02

(57) ABSTRACT

A vibration absorption apparatus and an electronic device. The electronic device includes a housing, a speaker, and a vibration absorption apparatus, where the speaker is disposed within the housing, and a first cavity is formed between the speaker and the housing; a casing of the speaker is provided with a first opening, the vibration absorption apparatus is disposed at the first opening, and the first opening communicates with the first cavity through the vibration absorption apparatus.

### CROSS-REFERENCES TO RELATED APPLICATIONS

This application is a continuation of International Application No. PCT/CN2023/094716 filed on May 17, 2023, which claims priority to Chinese Patent Application No. 202210573829.5 filed on May 24, 2022, which are incorporated herein by reference in their entireties.

### TECHNICAL FIELD

This application relates to the field of communication technology, and in particular, to a vibration absorption apparatus and an electronic device.

### BACKGROUND

A speaker module is an acoustic module used in electronic devices such as mobile phones, tablets, and laptops. To improve the overall appearance and aesthetics of electronic devices, current speaker modules are usually placed on the sides of the electronic devices. The speaker module includes a speaker and a speaker housing, with the speaker dividing the speaker housing into a front cavity and a rear cavity. Sound waves generated by the speaker are transmitted through the front cavity to a sound outlet of the housing of the electronic device, and finally transmitted to the external environment where the electronic device is located.

To achieve miniaturization of electronic devices, the spatial layout of components within the electronic device is compact, limiting the volume of the rear cavity of the speaker module, resulting in poor low-frequency performance of the speaker module.

### SUMMARY

According to a first aspect, an embodiment of this application provides an electronic device, the electronic device including a housing, a speaker, and a vibration absorption apparatus, where the speaker is disposed within the housing, and a first cavity is formed between the speaker and the housing;
where a casing of the speaker is provided with a first opening, the vibration absorption apparatus is disposed at the first opening, and the first opening communicates with the first cavity through the vibration absorption apparatus.

According to a second aspect, an embodiment of this application provides a vibration absorption apparatus, the vibration absorption apparatus including:
an accommodating structure, including a sound inlet and a sound outlet, where the sound inlet communicates with the sound outlet to form a sound transmission channel; and
a perforated vibration absorption structure, disposed within the accommodating structure, where the perforated vibration absorption structure is provided with a plurality of perforations, a second cavity is formed between the perforated vibration absorption structure and the accommodating structure, and the perforations connect the second cavity and the sound transmission channel.

According to a third aspect, an embodiment of this application provides an electronic device, where the electronic device includes the vibration absorption apparatus according to the second aspect.

### BRIEF DESCRIPTION OF DRAWINGS

FIG. 1 is a schematic structural diagram of an electronic device according to an embodiment of this application;

FIG. 2 is a first schematic structural diagram of a vibration absorption apparatus according to an embodiment of this application;

FIG. 3 is a second schematic structural diagram of a vibration absorption apparatus according to an embodiment of this application; and

FIG. 4 is a partial schematic structural diagram of a vibration absorption apparatus according to an embodiment of this application.

### DETAILED DESCRIPTION

The following clearly describes the technical solution in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

The terms “first”, “second”, and the like in this specification and claims of this application are used to distinguish between similar objects rather than to describe a specific order or sequence. It should be understood that data used in this way is used interchangeably in appropriate circumstances such that the embodiments of this application can be implemented in other orders than the order illustrated or described herein. In addition, “first” and “second” are usually used to distinguish objects of a same type, and do not restrict a quantity of objects. In addition, “and/or” in the specification and claims represents at least one of the connected objects, and the character “/” generally indicates that the contextually associated objects have an “or” relationship.

The vibration absorption apparatus and electronic device provided in the embodiments of this application are hereinafter described in detail by using specific embodiments and application scenarios thereof with reference to the accompanying drawings.

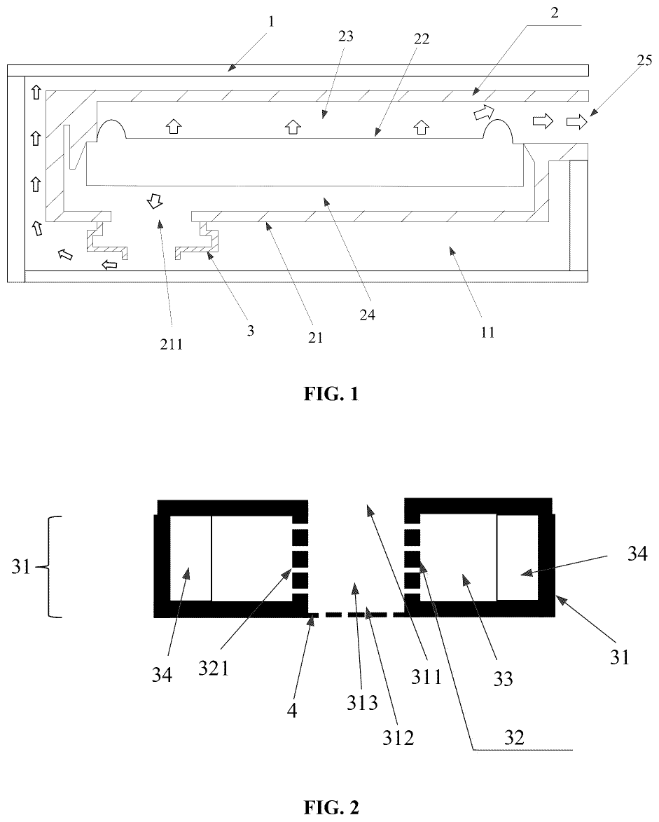

Referring to FIG. 1, FIG. 1 is a schematic structural diagram of an electronic device according to an embodiment of this application. As shown in FIG. 1, the electronic device includes a housing 1, a speaker 2, and a vibration absorption apparatus 3, where the speaker 2 is disposed within the housing 1, and a first cavity 11 is formed between the speaker 2 and the housing 1.

The casing 21 of the speaker 2 is provided with a first opening 211, the vibration absorption apparatus 3 is disposed at the first opening 211, and the first opening 211 communicates with the first cavity 11 through the vibration absorption apparatus 3.

The vibration absorption apparatus 3 may be assembled separately or integrally formed with the casing 21 of the speaker 2. The vibration absorption apparatus 3 may be an expansion pipe type resonant silencer, a porous material silencer, or the like. This embodiment does not limit the specific structure of the vibration absorption apparatus 3.

In one embodiment, as shown in FIG. 2, the vibration absorption apparatus 3 may include:
an accommodating structure 31 connected to the speaker 2, where the accommodating structure 31 includes a sound inlet 311 communicating with the first opening 211 and a sound outlet 312 communicating with the first cavity 11, and the sound inlet 311 communicates with the sound outlet 312 to form a sound transmission channel 313; and
a perforated vibration absorption structure 32 disposed within the accommodating structure 31, where the perforated vibration absorption structure 32 is provided with a plurality of perforations 321, a second cavity 33 is formed between the perforated vibration absorption structure 32 and the accommodating structure 31, and the perforations 321 connect the second cavity 33 and the sound transmission channel 313.

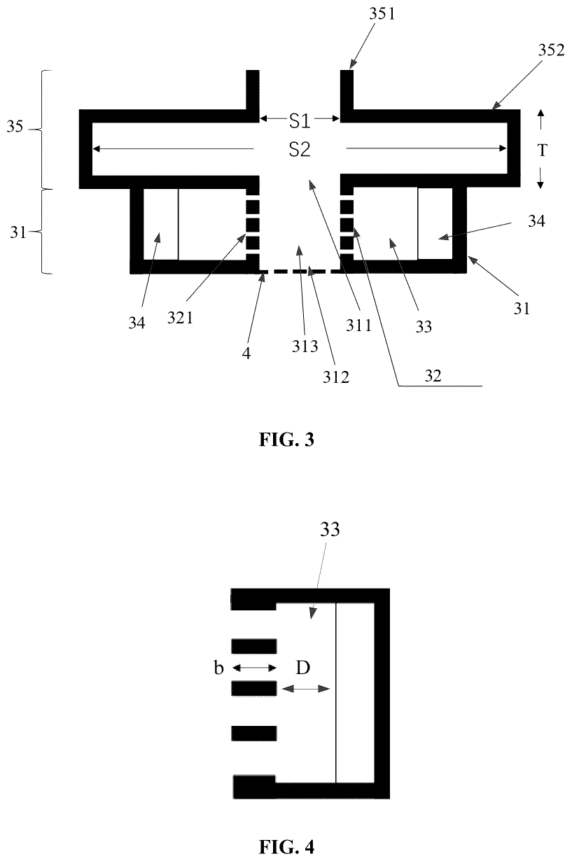

In one embodiment, as shown in FIG. 3, the vibration absorption apparatus 3 may include:
an expansion vibration absorption structure 35, where the expansion vibration absorption structure 35 includes a connecting pipe 351 and an expansion pipe 352, the connecting pipe 351 is connected to the expansion pipe 352, the connecting pipe 351 is disposed at the first opening 211, and the expansion pipe 352 communicates with the first cavity 11.

It should be noted that the first opening 211 can connect the rear cavity 24 of the speaker 2 and the first cavity 11, allowing the sound emitted by the speaker 2 to flow from the rear cavity 24 of the speaker 2 through the first opening 211 to the first cavity 11, which effectively increases the volume of the rear cavity 24 of the speaker 2, thereby enhancing the low-frequency performance of the speaker 2.

In one embodiment, the accommodating structure 31 and the perforated vibration absorption structure 32 constitute a perforated vibration absorption assembly, and the vibration absorption apparatus 3 may include a plurality of perforated vibration absorption assemblies; and/or, the vibration absorption apparatus 3 may include a plurality of expansion vibration absorption structures 35; where
in a case of a plurality of expansion vibration absorption structures 35, the plurality of expansion vibration absorption structures 35 are connected in series;
in a case of a plurality of perforated vibration absorption assemblies, the plurality of perforated vibration absorption assemblies are connected in series; or
in a case of a plurality of expansion vibration absorption structures 35 and a plurality of perforated vibration absorption assemblies, one expansion vibration absorption structure 35 and one perforated vibration absorption assembly are connected in series to form a vibration absorption unit, and a plurality of vibration absorption units are connected in series to form the vibration absorption apparatus 3.

In addition, taking two perforated vibration absorption assemblies connected in series as an example, the accommodating structure 31 of the first perforated vibration absorption assembly communicates with the first opening 211, the perforated vibration absorption structure 32 of the first perforated vibration absorption assembly communicates with the perforated vibration absorption structure 32 of the second perforated vibration absorption assembly, the accommodating structure 31 of the first perforated vibration absorption assembly is connected to the accommodating structure 31 of the second perforated vibration absorption assembly, and the sound inlet 311 and sound outlet 312 of the first perforated vibration absorption assembly, and the sound inlet 311 and sound outlet 312 of the second perforated vibration absorption assembly form a sound transmission channel, thereby achieving the series connection of two perforated vibration absorption assemblies. The method for connecting a plurality of perforated vibration absorption assemblies in series is similar.

Furthermore, taking two vibration absorption units connected in series as an example, the connecting pipe 351 of the expansion vibration absorption structure 35 of the first vibration absorption unit communicates with the first opening 211, the connecting pipe 351 of the expansion vibration absorption structure 35 of the second vibration absorption unit communicates with the accommodating structure 31 of the first vibration absorption unit, and the perforated vibration absorption structure 32 of the second vibration absorption unit communicates with the first cavity 11, thereby achieving the series connection of two vibration absorption units. The method for connecting a plurality of vibration absorption units in series is similar.

In this way, air vibrations passing through the multi-channel sound-absorbing structure, which includes a plurality of expansion vibration absorption structures 35 and/or a plurality of perforated vibration absorption structures 32, will have their resonant frequency sound waves significantly reduced when transmitted into the first cavity 11, greatly reducing the vibration of the housing 1.

It should be noted that when the back sound waves radiated by the speaker 2 pass through the rear cavity 24, they will continue to pass through the first opening 211 and propagate in the first cavity 11. The sound waves enter the vibration absorption apparatus 3 through the first opening 211, where the vibration absorption apparatus 3 attenuates the sound waves. In one embodiment, the vibration absorption frequency band of the vibration absorption apparatus 3 may include a target frequency, where the target frequency is a resonant frequency at which the housing 1 resonates with a sound emitted by the speaker 2. By using the vibration absorption apparatus 3, the sound waves at the target frequency that easily excite the vibration of the housing 1 are attenuated, while the sound waves in other frequency bands are minimally attenuated or essentially unaffected. When the sound waves pass through the vibration absorption apparatus 3 and enter the first cavity 11, the resonance intensity of the housing 1 is greatly reduced, improving the user experience.

Taking a mobile phone as an example of an electronic device, when the first opening 211 is not provided, the cavity formed by the casing 21 of the speaker 2 is nearly sealed, which can be referred to as a sealed BOX. In a sealed BOX, when the speaker 2 operates, it generates an air pressure change in the rear cavity 24 opposite to that in the front cavity 23. The air pressure change in the front cavity 23 ultimately propagates to the outside of the mobile phone along the direction of the arrows in the front cavity 23, forming the sound heard by the user; while the air pressure change in the rear cavity 24 is confined within the rear cavity 24, with only a negligible amount propagating outward through the casing 21 of the speaker 2. Due to the small volume of the rear cavity 24 in a sealed BOX, the low-frequency performance of the speaker 2 is poor. In the embodiment of this application, through the provision of the first opening 211 on the casing 21 of the speaker 2, the cavity formed by the casing 21 of the speaker 2 is no longer sealed, which can be referred to as an open BOX. The airflow inside the casing 21 of the speaker 2 can communicate with the airflow inside the first cavity 11, increasing the volume of the rear cavity 24, thereby enhancing the low-frequency performance of the speaker 2 and providing a better external sound experience for the mobile phone.

In the embodiment of this application, through the provision of the first opening 211 on the casing 21 of the speaker 2, and the first opening 211 communicating with the first cavity 11 through the vibration absorption apparatus 3, the internal space of the entire mobile phone can be fully utilized, and the issue of strong vibration sensation at the mobile phone battery cover can be resolved.

It should be noted that the speaker 2 in the embodiment of this application is particularly suitable for electronic devices with insufficient space and compact structures, such as virtual reality (VR) devices, augmented reality (AR) devices, mobile phones, tablets, and other electronic devices.

In the embodiment of this application, the electronic device includes a housing 1, a speaker 2, and a vibration absorption apparatus 3, where the speaker 2 is disposed within the housing 1, and a first cavity 11 is formed between the speaker 2 and the housing 1; the casing 21 of the speaker 2 is provided with a first opening 211, the vibration absorption apparatus 3 is disposed at the first opening 211, and the first opening 211 communicates with the first cavity 11 through the vibration absorption apparatus 3. In this way, the first opening 211 connects the interior of the speaker 2 with the first cavity 11, allowing the sound emitted by the speaker 2 to flow through the first opening 211 to the first cavity 11, thereby enhancing the low-frequency performance of the speaker 2; furthermore, the vibration absorption apparatus 3 can absorb vibrations to reduce the probability of resonance between the housing 1 and the sound emitted by the speaker 2.

Optionally, as shown in FIG. 2, the vibration absorption apparatus 3 includes:
an accommodating structure 31 connected to the speaker 2, where the accommodating structure 31 includes a sound inlet 311 communicating with the first opening 211 and a sound outlet 312 communicating with the first cavity 11, and the sound inlet 311 communicates with the sound outlet 312 to form a sound transmission channel; and
a perforated vibration absorption structure 32 disposed within the accommodating structure 31, where the perforated vibration absorption structure 32 is provided with a plurality of perforations, a second cavity 33 is formed between the perforated vibration absorption structure 32 and the accommodating structure 31, and the perforations connect the second cavity 33 and the sound transmission channel.

The accommodating structure 31 may be a square accommodating structure 31, a circular accommodating structure 31, or other shapes of accommodating structures 31. This embodiment does not limit the shape of the accommodating structure 31.

In addition, the perforated vibration absorption structure 32 may be a pipe, with two ends of the pipe respectively communicating with the sound inlet 311 and the sound outlet 312, where the sound inlet 311 and the sound outlet 312 of the accommodating structure 31 and the pipe form a sound transmission channel; or, a plurality of perforated vibration absorption structures 32 enclose the sound transmission channel.

It should be noted that the perforated vibration absorption structure 32 can achieve resonant sound absorption through the plurality of perforations provided. Sound waves act on the perforated vibration absorption structure 32, causing the perforated vibration absorption structure 32 to vibrate back and forth, thereby absorbing the sound wave energy and converting it into vibrational energy for dissipation. Typically, the energy of the sound waves is insufficient to cause the perforated vibration absorption structure 32 to vibrate, and only during resonance does it cause the perforated vibration absorption structure 32 to vibrate. The resonant frequency of the perforations on the perforated vibration absorption structure 32 can be changed, thereby changing the frequency of the absorbed sound waves.

In one embodiment, as shown in FIG. 4, through the adjustment of the perforation ratio of the perforated vibration absorption structure 32, the cavity depth D of the second cavity 33, and the side wall thickness b of the perforated vibration absorption structure 32, the resonant frequency of the perforated vibration absorption structure 32 can be changed, thereby changing the sound absorption frequency of the perforated vibration absorption structure 32. The sound absorption frequency of the perforated vibration absorption structure 32 may be the target frequency, where the target frequency is the resonant frequency at which the housing 1 resonates with the sound emitted by the speaker 2.

In this way, air vibrations passing through the perforated vibration absorption structure 32 will have their sound waves significantly reduced when transmitted into the first cavity 11, greatly reducing the vibration of the housing 1.

Optionally, the perforated vibration absorption structure 32 is a pipe, where two ends of the perforated vibration absorption structure 32 respectively communicate with the sound inlet 311 and the sound outlet 312, the sound transmission channel is located on an inner side of the perforated vibration absorption structure 32, and a plurality of perforations are provided on a side wall of the perforated vibration absorption structure 32;
and/or
the vibration absorption apparatus 3 includes a plurality of perforated vibration absorption structures 32, and the plurality of perforated vibration absorption structures 32 enclose the sound transmission channel.

The perforated vibration absorption structure 32 is a pipe, where the pipe may be a square pipe, a circular pipe, or other shapes of pipes. This is not limited in this embodiment. The perforated vibration absorption structure 32 may be a pipe formed by a perforated plate.

In addition, the perforated vibration absorption structure 32 may be a perforated plate, where a plurality of perforated plates enclose the sound transmission channel.

It should be noted that the perforated vibration absorption structure 32 implements resonant sound absorption through a side wall of the perforated vibration absorption structure 32. Sound waves act on the side wall, causing the side wall to vibrate back and forth, thereby absorbing the sound wave energy and converting it into vibrational energy for dissipation.

Optionally, as shown in FIG. 2, a sound-absorbing material 34 is disposed within the second cavity 33.

The sound-absorbing material 34 may be disposed near the side wall of the accommodating structure 31 forming the second cavity 33. The sound-absorbing material 34 may include hemp velvet, petroleum fiber cotton, sponge, aluminum silicate cotton, and the like.

In this embodiment, the perforated vibration absorption structure 32 can not only absorb specific frequency sound waves through the perforations on the side wall, but also assist the perforations on the side wall to absorb the specific frequency sound waves through the sound-absorbing material 34 disposed inside the second cavity 33, thereby improving the sound absorption effect of the perforated vibration absorption structure 32.

Optionally, the plurality of perforations provided on the perforated vibration absorption structure 32 are arranged at intervals along the sound transmission direction, the sound transmission direction pointing from the sound inlet to the sound outlet.

The perforated vibration absorption structure 32 may be a pipe, and the sound transmission direction may point from the end of the perforated vibration absorption structure 32 communicating with the sound inlet 311 to the end of the perforated vibration absorption structure 32 communicating with the sound outlet 312. Through the plurality of perforations arranged at intervals along the sound transmission direction on the perforated vibration absorption structure 32, a better sound absorption effect can be implemented.

Optionally, the sound absorption frequency of the perforated vibration absorption structure 32 is a target frequency, where the target frequency is a resonant frequency at which the housing 1 resonates with the sound emitted by the speaker 2; where
the sound absorption frequency of the perforated vibration absorption structure 32 is proportional to a perforation ratio of the perforated vibration absorption structure 32, inversely proportional to a cavity depth of the second cavity 33, and inversely proportional to a side wall thickness of the perforated vibration absorption structure 32.

In one embodiment, the sound absorption frequency f of the perforated vibration absorption structure 32 may be:

$$f = \frac{c}{2 π} \sqrt{\frac{p}{{L}_{k} D}} ,$$

c is the speed of sound, p is the perforation ratio of the perforated vibration absorption structure 32, and D is the cavity depth of the second cavity 33.

The parameter Lₖ is:

$${L}_{k} = b + 0.8 + \frac{pD}{3} ,$$

b is the side wall thickness of the perforated vibration absorption structure 32.

Optionally, as shown in FIG. 3, the vibration absorption apparatus 3 includes:
at least one expansion vibration absorption structure 35, where the expansion vibration absorption structure 35 includes a connecting pipe 351 and an expansion pipe 352, the connecting pipe 351 is connected to the expansion pipe 352, and the connecting pipe 351 is disposed at the first opening 211; where
the expansion pipe 352 is connected to the accommodating structure 31, and the first opening 211 communicates with the first cavity 11 sequentially through the connecting pipe 351, the expansion pipe 352, and the sound transmission channel.

The connecting pipe 351 may be a square pipe, a circular pipe, or other shapes of pipes. This embodiment does not limit the shape of the connecting pipe 351. The expansion pipe 352 may form a hollow cylindrical cavity, a hollow square cavity, or a cavity of other shapes. This embodiment does not limit the shape of the cavity formed by the expansion pipe 352.

In one embodiment, the connecting pipe 351 is a circular pipe, and the expansion pipe 352 forms a hollow cylindrical cavity.

In one embodiment, a diameter of the pipe formed by the perforated vibration absorption structure 32 may be the same as the diameter of the pipe of the connecting pipe 351.

In one embodiment, the expansion pipe 352 is provided with a second opening and a third opening respectively on its two opposite side walls, where the second opening communicates with the perforated vibration absorption structure 32, and the third opening communicates with the connecting pipe 351.

A cross-sectional area of the second opening may be the same as a cross-sectional area of the pipe formed by the perforated vibration absorption structure 32, where the cross-sectional area of the pipe is an area of a cross-section perpendicular to the centerline of the pipe. A cross-sectional area of the third opening may be the same as a cross-sectional area of the connecting pipe 351, where the cross-sectional area of the connecting pipe 351 is an area of a cross-section perpendicular to the centerline of the connecting pipe 351.

In one embodiment, the cross-sectional area of the pipe formed by the perforated vibration absorption structure 32 may be the same as the cross-sectional area of the connecting pipe 351, facilitating the flow of sound waves from the pipe formed by the perforated vibration absorption structure 32 to the connecting pipe 351, providing a better transmission path for the sound waves.

In this way, air vibrations passing through the two-channel sound-absorbing structure, which includes the expansion vibration absorption structure 35 and the perforated vibration absorption structure 32, will have their target frequency sound waves significantly reduced when transmitted into the first cavity 11, greatly reducing the vibration of the housing 1.

Optionally, the vibration absorption apparatus 3 includes:
an expansion vibration absorption structure 35, where the expansion vibration absorption structure 35 includes a connecting pipe 351 and an expansion pipe 352, the connecting pipe 351 is connected to the expansion pipe 352, and the connecting pipe 351 is disposed at the first opening 211, and the first opening 211 communicates with the first cavity 11 through the connecting pipe 351 and the expansion pipe 352.

The length of the pipe of the expansion pipe 352 may be one-quarter of a target frequency, where the target frequency is the resonant frequency at which the housing 1 resonates with the sound emitted by the speaker 2.

In one embodiment, a sound transmission coefficient of the expansion vibration absorption structure 35 may be:

$${t}_{I} = \frac{4}{4 cos ( \frac{2 π f}{c} T ) + {( \frac{S 1}{S 2} + \frac{S 2}{S 1} )}^{2} sin \frac{2 π f}{c} T} ,$$

f is a frequency of the sound wave, and c is the speed of sound. As shown in FIG. 3, S2 is the cross-sectional area of the expansion pipe 352, S1 is the cross-sectional area of the connecting pipe 351, and T is a length of the expansion pipe 352. According to the formula for the sound transmission coefficient, when the length T of the expansion pipe 352 is one-quarter of the wavelength of the sound wave, the sound transmission coefficient is minimized, and the reflection coefficient is the strongest, which can effectively reduce noise.

Optionally, the vibration absorption apparatus 3 includes a plurality of expansion vibration absorption structures 35, where the expansion pipe 352 of one expansion vibration absorption structure 35 is connected to the connecting pipe 351 of another adjacent expansion vibration absorption structure 35.

For example, taking two expansion vibration absorption structures 35 connected in series as an example, the connecting pipe 351 of the first expansion vibration absorption structure 35 communicates with the first opening 211, the connecting pipe 351 of the second expansion vibration absorption structure 35 communicates with the expansion pipe 352 of the first expansion vibration absorption structure 35, and the expansion pipe 352 of the second expansion vibration absorption structure 35 communicates with the first cavity 11, thereby achieving a series connection of the two expansion vibration absorption structures 35. The method of connecting a plurality of expansion vibration absorption structures 35 in series is similar.

Optionally, as shown in FIG. 1, the speaker 2 includes a diaphragm 22, where the diaphragm 22 divides the speaker 2 into a front cavity 23 and a rear cavity 24, the front cavity 23 communicates with the sound outlet hole 25 of the speaker 2, the first opening 211 is disposed on a side wall of the casing 21 forming the rear cavity 24, and the rear cavity 24 communicates with the first cavity 11 through the first opening 211 and the vibration absorption apparatus 3.

The front cavity 23 and the rear cavity 24 may be isolated from each other.

Optionally, the vibration absorption frequency band of the vibration absorption apparatus 3 includes a target frequency, where the target frequency is a resonant frequency at which the housing 1 resonates with a sound emitted by the speaker 2.

It should be noted that if the frequency of the airflow caused by the sound emitted by the speaker 2 and leaked to the housing 1 is near the target frequency, the housing 1 itself will resonate. Through the provision of the vibration absorption apparatus 3, where the vibration absorption apparatus 3 has a vibration absorption frequency band that includes the target frequency, the vibration absorption apparatus 3 can reduce the airflow, with a frequency of the airflow near the target frequency, in the housing 1 caused by the sound emitted by the speaker 2 and leaked to the housing 1, thereby reducing the possibility of resonance between the housing 1 and the sound emitted by the speaker 2, and potentially eliminating resonance.

In one embodiment, the center frequency of the vibration absorption frequency band of the vibration absorption apparatus 3 is the target frequency.

The vibration absorption apparatus 3 has the best absorption effect on the airflow at the center frequency of the vibration absorption frequency band. For example, the maximum value of the vibration absorption frequency of the vibration absorption apparatus 3 may be frequency a, the minimum value of the vibration absorption frequency of the vibration absorption apparatus 3 may be frequency b, and the center frequency of the vibration absorption frequency band of the vibration absorption apparatus 3 may be (a+b)/2.

In this way, the vibration absorption apparatus 3 can better eliminate the airflow near the target frequency, further reducing the possibility of resonance between the housing 1 and the sound emitted by the speaker 2.

Optionally, the electronic device further includes a damping mesh 4 provided between the vibration absorption apparatus 3 and the housing 1, where the first opening 211 communicates with the first cavity 11 through the vibration absorption apparatus 3 and the damping mesh 4.

The vibration absorption apparatus 3 may include an accommodating structure 31, as shown in FIG. 3, and the damping mesh 4 may be provided at the sound outlet 312 of the accommodating structure 31. The damping mesh 4 may be a mesh fabric with high acoustic resistance. Through the provision of the damping mesh 4 between the vibration absorption apparatus 3 and the housing 1, the air pressure changes of the airflow passing through the damping mesh 4 can be effectively reduced, thereby implementing the effect of balancing air pressure.

An embodiment of this application embodiment further provides a vibration absorption apparatus 3, where the vibration absorption apparatus 3 includes:
an accommodating structure 31 including a sound inlet 311 and a sound outlet 312, where the sound inlet 311 communicates with the sound outlet 312 to form a sound transmission channel; and
a perforated vibration absorption structure 32 disposed within the accommodating structure 31, where the perforated vibration absorption structure 32 is provided with a plurality of perforations, a second cavity 33 is formed between the perforated vibration absorption structure 32 and the accommodating structure 31, and the perforations connect the second cavity 33 and the sound transmission channel.

Optionally, the perforated vibration absorption structure 32 is a pipe, where two ends of the perforated vibration absorption structure 32 respectively communicate with the sound inlet 311 and the sound outlet 312, the sound transmission channel is located on an inner side of the perforated vibration absorption structure 32, and a plurality of perforations are provided on a side wall of the perforated vibration absorption structure 32;
and/or
the vibration absorption apparatus 3 includes a plurality of perforated vibration absorption structures 32, and the plurality of perforated vibration absorption structures 32 enclose the sound transmission channel.

Optionally, a sound-absorbing material 34 is disposed within the second cavity 33.

Optionally, the plurality of perforations provided on the perforated vibration absorption structure 32 are arranged at intervals along the sound transmission direction.

Optionally, the sound absorption frequency of the perforated vibration absorption structure 32 is proportional to a perforation ratio of the perforated vibration absorption structure 32, inversely proportional to a cavity depth of the second cavity 33, and inversely proportional to a side wall thickness of the perforated vibration absorption structure 32.

Optionally, the vibration absorption apparatus 3 includes:
at least one expansion vibration absorption structure 35, where the expansion vibration absorption structure 35 includes a connecting pipe 351 and an expansion pipe 352, and the connecting pipe 351 is connected to the expansion pipe 352; where
the expansion pipe 352 is connected to the accommodating structure 31.

An embodiment of this application embodiment further provides a vibration absorption apparatus 3, where the vibration absorption apparatus 3 includes:
an expansion vibration absorption structure 35, where the expansion vibration absorption structure 35 includes a connecting pipe 351 and an expansion pipe 352, and the connecting pipe 351 is connected to the expansion pipe 352.

An embodiment of this application further provides an electronic device, where the electronic device includes the vibration absorption apparatus described in the embodiments of this application.

The electronic device in the embodiments of this application may be a mobile electronic device or a non-mobile electronic device. For example, the mobile electronic device may be a mobile phone, a tablet computer, a notebook computer, a palmtop computer, a vehicle-mounted electronic device, a wearable device, an ultra-mobile personal computer (UMPC), a netbook, or a personal digital assistant (PDA), and the non-mobile electronic device may be a personal computer (PC), a television (TV), a teller machine, a self-service machine, or the like. This is not specifically limited in the embodiments of this application.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the method and apparatus in the implementations of this application is not limited to functions being performed in the order shown or discussed, but may further include functions being performed at substantially the same time or in a reverse order, depending on the functions involved. For example, the described method may be performed in an order different from that described, and various steps may be added, omitted, or combined. In addition, features described with reference to some examples may be combined in other examples.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may develop many other manners without departing from principles of this application and the protection scope of the claims, and all such manners fall within the protection scope of this application.

What is claimed is:

1. An electronic device, the electronic device comprising a housing, a speaker, and a vibration absorption apparatus, wherein the speaker is disposed within the housing, and a first cavity is formed between the speaker and the housing; wherein
a casing of the speaker is provided with a first opening, the vibration absorption apparatus is disposed at the first opening, and the first opening communicates with the first cavity through the vibration absorption apparatus.

2. The electronic device according to claim 1, wherein the vibration absorption apparatus comprises:
an accommodating structure connected to the speaker, wherein the accommodating structure comprises a sound inlet communicating with the first opening and a sound outlet communicating with the first cavity, and the sound inlet communicates with the sound outlet to form a sound transmission channel; and
a perforated vibration absorption structure disposed within the accommodating structure, wherein the perforated vibration absorption structure is provided with a plurality of perforations, a second cavity is formed between the perforated vibration absorption structure and the accommodating structure, and the perforations connect the second cavity and the sound transmission channel.

3. The electronic device according to claim 2, wherein the perforated vibration absorption structure is a pipe, two ends of the perforated vibration absorption structure respectively communicate with the sound inlet and the sound outlet, the sound transmission channel is located on an inner side of the perforated vibration absorption structure, and a plurality of perforations are provided on a side wall of the perforated vibration absorption structure;
and/or
the vibration absorption apparatus comprises a plurality of perforated vibration absorption structures, and the plurality of perforated vibration absorption structures enclose the sound transmission channel.

4. The electronic device according to claim 2, wherein a sound-absorbing material is disposed within the second cavity.

5. The electronic device according to claim 2, wherein the plurality of perforations provided on the perforated vibration absorption structure are arranged at intervals along a sound transmission direction, wherein the sound transmission direction points from the sound inlet to the sound outlet.

6. The electronic device according to claim 2, wherein a sound absorption frequency of the perforated vibration absorption structure comprises a target frequency, wherein the target frequency is a resonant frequency at which the housing resonates with a sound emitted by the speaker; wherein
the sound absorption frequency of the perforated vibration absorption structure is proportional to a perforation ratio of the perforated vibration absorption structure, inversely proportional to a cavity depth of the second cavity, and inversely proportional to a side wall thickness of the perforated vibration absorption structure.

7. The electronic device according to claim 2, wherein the vibration absorption apparatus comprises:
at least one expansion vibration absorption structure, wherein the expansion vibration absorption structure comprises a connecting pipe and an expansion pipe, the connecting pipe is connected to the expansion pipe, and the connecting pipe is disposed at the first opening; wherein
the expansion pipe is connected to the accommodating structure, the first opening communicates with the first cavity sequentially through the connecting pipe, the expansion pipe, and the sound transmission channel.

8. The electronic device according to claim 1, wherein the vibration absorption apparatus comprises:
an expansion vibration absorption structure, wherein the expansion vibration absorption structure comprises a connecting pipe and an expansion pipe, the connecting pipe is connected to the expansion pipe, the connecting pipe is disposed at the first opening, and the first opening communicates with the first cavity through the connecting pipe and the expansion pipe.

9. The electronic device according to claim 7, wherein the vibration absorption apparatus comprises a plurality of expansion vibration absorption structures, wherein the expansion pipe of the expansion vibration absorption structure is connected to a connecting pipe of another adjacent expansion vibration absorption structure.

10. The electronic device according to claim 1, wherein the speaker comprises a diaphragm, the diaphragm divides the speaker into a front cavity and a rear cavity, the front cavity communicates with a sound outlet hole of the speaker, the first opening is disposed on a side wall of the casing forming the rear cavity, and the rear cavity communicates with the first cavity through the first opening and the vibration absorption apparatus.

11. The electronic device according to claim 1, wherein a vibration absorption frequency band of the vibration absorption apparatus comprises a target frequency, and the target frequency is a resonant frequency at which the housing resonates with a sound emitted by the speaker.

12. The electronic device according to claim 1, wherein the electronic device further comprises a damping mesh disposed between the vibration absorption apparatus and the housing, and the first opening communicates with the first cavity through the vibration absorption apparatus and the damping mesh.

13. A vibration absorption apparatus, wherein the vibration absorption apparatus comprises:
an accommodating structure comprising a sound inlet and a sound outlet, wherein the sound inlet communicates with the sound outlet to form a sound transmission channel; and
a perforated vibration absorption structure disposed within the accommodating structure, wherein the perforated vibration absorption structure is provided with a plurality of perforations, a second cavity is formed between the perforated vibration absorption structure and the accommodating structure, and the perforations connect the second cavity and the sound transmission channel.

14. The vibration absorption apparatus according to claim 13, wherein the perforated vibration absorption structure is a pipe, two ends of the perforated vibration absorption structure respectively communicate with the sound inlet and the sound outlet, the sound transmission channel is located on an inner side of the perforated vibration absorption structure, and a plurality of perforations are provided on a side wall of the perforated vibration absorption structure.

15. The vibration absorption apparatus according to claim 13, the vibration absorption apparatus comprises a plurality of perforated vibration absorption structures, and the plurality of perforated vibration absorption structures enclose the sound transmission channel.

16. The vibration absorption apparatus according to claim 13, wherein a sound-absorbing material is disposed within the second cavity.

17. The vibration absorption apparatus according to claim 13, wherein the plurality of perforations provided on the perforated vibration absorption structure are arranged at intervals along a sound transmission direction, wherein the sound transmission direction points from the sound inlet to the sound outlet.

18. The vibration absorption apparatus according to claim 13, wherein a sound absorption frequency of the perforated vibration absorption structure comprises a target frequency, wherein the target frequency is a resonant frequency at which a housing resonates with a sound emitted by a speaker; wherein
the sound absorption frequency of the perforated vibration absorption structure is proportional to a perforation ratio of the perforated vibration absorption structure, inversely proportional to a cavity depth of the second cavity, and inversely proportional to a side wall thickness of the perforated vibration absorption structure.

19. The vibration absorption apparatus according to claim 13, wherein the vibration absorption apparatus comprises:
at least one expansion vibration absorption structure, wherein the expansion vibration absorption structure comprises a connecting pipe and an expansion pipe, the connecting pipe is connected to the expansion pipe, and the connecting pipe is disposed at the first opening; wherein
the expansion pipe is connected to the accommodating structure, the first opening communicates with the first cavity sequentially through the connecting pipe, the expansion pipe, and the sound transmission channel.

20. The vibration absorption apparatus according to claim 19, wherein the vibration absorption apparatus comprises a plurality of expansion vibration absorption structures, wherein the expansion pipe of the expansion vibration absorption structure is connected to a connecting pipe of another adjacent expansion vibration absorption structure.
